(19) United States
(12) Patent Application Publication
(10) Pub. No.: US 2016/0076153 A1
(43) Pub. Date: Mar. 17, 2016

(54) CAN PRODUCTION PROCESS

(71) Applicants: Michael Alexander COCHRAN, Wantage Oxfordshire (GB); Grahame HUGHES, Wantage Oxfordshire (GB); CROWN PACKAGING TECHNOLOGY INC, Alsip, IL (US)

(72) Inventors: Michael Alexander COCHRAN, Oxfordshire (GB); Grahame HUGHES, Oxfordshire (GB)

(21) Appl. No.: 14/784,784

(22) PCT Filed: Apr. 11, 2014
(86) PCT No.: PCT/EP2014/057390

§ 371 Date: Oct. 15, 2015

(30) Foreign Application Priority Data
Apr. 17, 2013 (GB) 1306986.9

(51) Int. Cl. C23G 5/00; B05D 7/14

(52) U.S. Cl. CPC C23G 5/00; B05D 7/14

(57) ABSTRACT

A method of at least partially removing an oxide layer from the surface of an aluminium work piece or product. The method comprises introducing the work piece or product into a processing chamber and exposing the work piece or product to a solid particulate cleaning material. This material comprises a multiplicity of particles.

### TECHNICAL FIELD

The present invention relates to a can production process and more particularly to an improved process for producing aluminium cans, such as aluminium beverage cans.

### BACKGROUND

In a typical aluminium can production process it is necessary to clean the aluminium material at a number of different stages in the production process, for example, to remove dirt and liquid films from the material. A typical cleaning stage might involve dipping the aluminium material, either prior to forming the can body or after such formation, in, or spraying the material with, water, possibly containing a detergent.

As is well known, when exposed to air, aluminium undergoes oxidation to form an oxide layer on its surface. During a can production process the oxide layer will crack resulting in a visible deterioration of the surface. In order to improve the surface finish and make the surface suitable for ink printing it is necessary to remove the cracked oxide layer. The conventional water based cleaning stages described above are not suitable for removing the oxide layer. Conventional production processes therefore include one or more further cleaning stages which make use of hydrofluoric acid. Of course, in such a stage, it is necessary to subsequently remove or rinse the material to remove any traces of hydrofluoric acid.

It will be appreciated that the use of hydrofluoric acid to remove an oxide layer from aluminium has both environmental and cost implications, particularly as disposal of waste hydrofluoric acid is subject to stringent requirements.

### SUMMARY

According to the present invention there is provided a method of at least partially removing an oxide layer from the surface of an aluminium work piece or product. The method comprises introducing the work piece or product into a processing chamber and exposing the work piece or product to a solid particulate cleaning material. This material comprises a multiplicity of particles.

In certain embodiments of the invention, the solid particulate cleaning material may comprise a multiplicity of polymer particles, and the solid particulate cleaning material may be combined with a liquid, e.g. water.

The particles of said solid particulate cleaning material may be impregnated and/or coated with a material that is transferred, as a result of the step of exposing, to the surface of the work piece or product. This transfer may be achieved primarily by direct physical contact between the particulate material and the surface. Alternatively, the transfer of said material, from the particulate material to the surface, may be achieved primarily by one or more of a temperature induced transfer, application of an electrical potential or magnetic field, a pressure induced transfer. The coating or impregnating material may be an inorganic material. The coating or impregnating material may be an organic material.

### BRIEF DESCRIPTION OF THE DRAWINGS

FIG. 1 illustrates schematically various stages in a can production process.

### DETAILED DESCRIPTION

It is known to employ a solid particulate cleaning material for the cleaning of textiles. Such a cleaning material might comprise a multiplicity of polymeric particles, for example, a multiplicity of nylon beads. A relatively small volume of liquid is introduced into the material in order to lubricate the “flow” of the particles within a cleaning chamber. Embodiments of this known textile cleaning approach make use of an apparatus comprising a drum that is rotated to allow the mechanical interaction of the cleaning material with the textile to be cleaned.

For further details of the known textile cleaning processes reference should be made to: WO2012/098408; WO2012/056252; WO2012/095677; WO2012/035353; WO2012/035342; WO2011/128680; WO2011/098815; WO2011/064581; WO2010/0128337; WO2010/094959.

It is proposed here to employ the known processes for cleaning textiles and using a particulate cleaning material, for the purpose of removing an oxide layer, and in particular a visibly damaged oxide layer, from an aluminium work piece or product. The proposed process finds particular application in the production of aluminium beverage cans where it is required to remove a damaged oxide layer prior to ink printing of the can surface. The proposed process may replace existing oxide removal processes that employ hydrofluoric acid. The cost and environmental benefits are potentially significant.

A possible embodiment of this process is incorporated into a beverage can production line. The embodiment employs a chamber through which the production line passes. The beverage cans are introduced into the chamber on a conveyor. Within the conveyor the cans are exposed to a particular particulate cleaning material, for example, nylon beads having a density in the range 0.5-2.5 g/cm³ and a volume in the range 5-275 mm³. In order to achieve that sufficient contact between the cans and the cleaning material the cleaning material may be sprayed into the chamber and recirculated. Alternatively the chamber might be agitated, e.g. shaken. According to the known textile cleaning processes a volume of liquid, for example, water, may be combined with the cleaning material. The particulate material may be applied in a pulsating manner, e.g. being forced through one or more nozzles.

In addition to using this approach to remove an oxide layer from aluminium work pieces and products, the approach may be used at other stages in a production line in order to clean the work piece. Additionally, or alternatively, the approach may be modified in order to apply a coating to the work piece or product. This might be achieved, for example, by mixing the coating into the particulate material, or employing pre-coated particles. For example, the particles can be pre-coated or impregnated with inorganic substances, which are then transferred to the metal substrate or metal component, such as a beverage can, during a subsequent washing process. This may enhance corrosion resistance, provide passivation of the surface, improve lacquer or printing adhesion and may reduce unwanted oxide growth (for example if it is required to store the substrates or components for prolonged periods before further coating). Inorganic substances that may be used in these processes include, for example, titanium, molybdenum, and zirconium. In some cases, the particles may be coated or impregnated with an organic material, This approach may be used to apply paint to the surface, to apply a protective finish, resin, extrusion coating, polymer film, reactive compound, pigmented resin, tactile or visual surface coating. The material may contain carbon, hydrogen, in combination with any/all other non-metal elements. The material particles may be coated or impregnated with a biocide.

By way of further example, these approaches may be used to achieve the following:

Coatings:
Decoration—colour, e.g. pigmented or dye containing films, interference effects, eg “oil-slick” or view-angle dependent colours, holographic effects/micro-embossing.
Decoration—surface finish, eg “brushed” effect, tactile effect, matt effects, gloss effects.
Protection of the internal surface from the product contents (e.g. a carbonated drink)—controlling and/or prevention of corrosion reactions, perforation of the container, leakage.
Protection of the product contents from the metal surface—controlling and/or prevention of metal dissolution and permeation into the product, controlling and/or prevention of flavour modification of the product by the metal surface, controlling and/or prevention of migration of/destruction of product components.
Metal protection using Bisphenol A (BPA) free (super-compliant simplified coatings).
Metal protection using purely inorganic coatings—ie removing organics completely.

Surface Treatments:
Passivation of plain exposed surfaces (stability over time).
Surface friction modification to aid mobility and handling, or reduce damage to unprotected clean metal surfaces (scratches, marring, other visual marks).
Coating adhesion promotion to the metal.
Coating adhesion promotion to a coated metal surface.

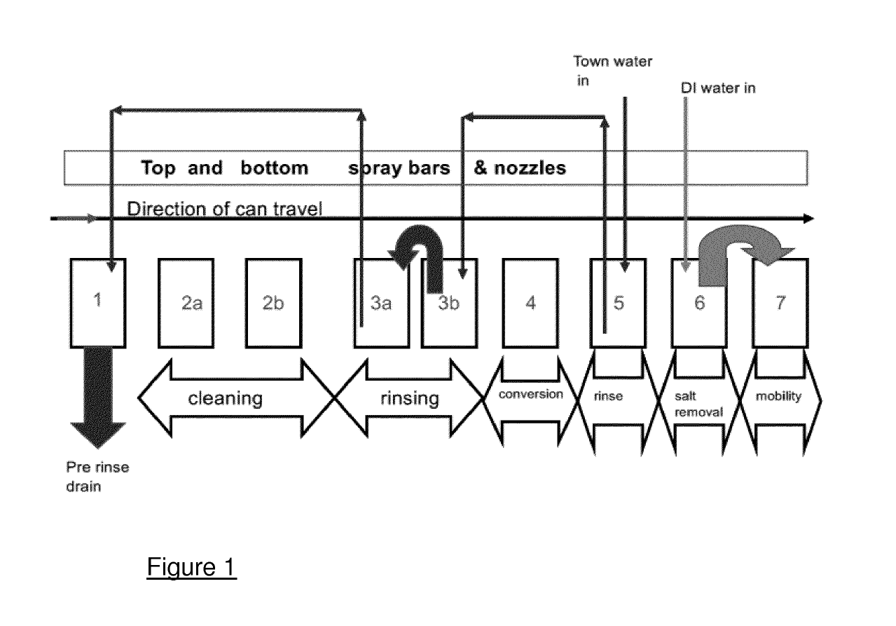

FIG. 1 illustrates schematically the incorporation of an oxide removal and cleaning station into a can production line, and embodying the principles described above. The various stages are as follows:
Before Pre-Rinse Stage Washing
   cans are contaminated with for example lubricants that must be removed.
Pre-Rinse (Stage 1)
   This water is taken from the 1st rinse stage
   It is the most contaminated water. May be recirculated but ultimately goes to treatment and/or drain.
   Function is to remove most of the residual coolant and other water soluble contaminants.
Pre-Wash (Stage 2a)
   Temperature˜50-60° C.
   controlled pH
   Purpose is to remove most of the oil to keep stage 2b as clean as possible
   The high temperature and low pH causes oils to break out of emulsion and float to surface—and overflow to waste.
Wash (Stage 2b)
   This is a modified stage that introduces bead cleaning as described above. Beads may be injected into the cleaning chamber via a set of nozzles.
   Beads are cleaned and recycled.
Drag Out Tank (Stage 3a)
   controlled pH
   Surface flocculants overflow to waste
1^{st} Rinse (Stage 3b)
   Uses water from 2^{nd} rinse stage
   controlled pH
Treatment (Stage 4)
   Uses zirconium, phosphate and fluoride
   Purpose is to grow a high integrity oxide film on the can surface to provide protection and excellent lacquer adhesion
2^{nd} Rinse (Stage 5)
DI rinse (stage 6)
Mobility Enhancer (stage 7)
   Deposits a very thin organic coating onto external can surface
   Purpose is to improve can handling, drying and decorating processes
   The ME may be added to the DI rinse stage but preferred process is to keep stage 7 separate to stage 6.

It will be appreciated by a person skilled in the art that various modifications may be made to the above described embodiments without departing from the scope of the present invention.

1. A method of at least partially removing an oxide layer from the surface of an aluminium work piece or product, the method comprising introducing the work piece or product into a processing chamber and exposing the work piece or product to a solid particulate cleaning material.

2. A method according to claim 1, wherein said solid particulate cleaning material comprises a multiplicity of polymer particles.

3. A method according to claim 1 and comprising combining said solid particulate cleaning material with a liquid.

4. A method according to claim 3, wherein said liquid is water.

5. A method according to any claim 1, wherein particles of said solid particulate cleaning material are impregnated and/or coated with a material that is transferred, as a result of the step of exposing, to the surface of the work piece or product.

6. A method according to claim 5, wherein the transfer of said material, from the particulate material to the surface, is achieved primarily by direct physical contact between the particulate material and the surface.

7. A method according to claim 5, wherein the transfer of said material, from the particulate material to the surface, is achieved primarily by one or more of a temperature induced transfer, application of an electrical potential or magnetic field, a pressure induced transfer.

8. A method according to claim 5, wherein the coating or impregnating material is an inorganic material.

9. A method according to claim 5, wherein the coating or impregnating material is an organic material.

10. A method of manufacturing an aluminium can, the method comprising using the method of claim 1 to remove an oxide layer formed on surfaces of the can.

11. A method according to claim 10 and comprising locating aluminium cans on a moving conveyor whereby the cans are introduced into a chamber where they are exposed to said particulate material.
